(19) United States
(12) Patent Application Publication
(10) Pub. No.: US 2026/0292552 A1
(43) Pub. Date: Sep. 24, 2026

(54) CONTROL OF RADIO MEASUREMENTS

(71) Applicant: Nokia Technologies Oy, Espoo (FI)

(72) Inventors: Hussein ABDULRAHMAN, Espoo (FI); Janne ALI-TOLPPA, Espoo (FI)

(21) Appl. No.: 19/473,607

(22) PCT Filed: May 7, 2024
(86) PCT No.: PCT/IB2024/054444

§ 371 Date: Oct. 8, 2025

(30) Foreign Application Priority Data
May 12, 2023 (GB) 2307062.6

(51) Int. Cl. H04W 24/08; H04L 41/147; H04L 41/16

(52) U.S. Cl. CPC H04W 24/08; H04L 41/147; H04L 41/16

(57) ABSTRACT

A user equipment comprising: means for making radio measurements for radio cells in a first set, but not a second set; means for using the radio measurements to obtain a prediction of availability, for connection, of the second set of radio cells, wherein the first set of radio cells and the second set of radio cells are distinct having no cells in common; and means for, in dependence upon the prediction, making radio measurements for connection to a radio cell in the second set. A network node comprising means for using radio measurements for radio cells in a first set to enable prediction of availability, for connection, of a second set of radio cells, wherein the first set of radio cells and the second set of radio cells are distinct having no cells in common.

### TECHNOLOGICAL FIELD

Examples of the disclosure relate to control of user equipment radio measurements in a cellular telecommunications system.

### BACKGROUND

A user equipment in a cellular radio telecommunications system makes radio measurements for radio cells of the system, for example, for the purposes of mobility management and handover between radio cells. The radio measurements made can, for example, be reported to a network where they are used to select or change a serving radio cell for the user equipment. Measurements can also be made for other purposes. There is a cost to the user equipment (and also the network) in making and reporting these measurements.

### BRIEF SUMMARY

According to various, but not necessarily all, examples there is provided a user equipment comprising:
means for making radio measurements for radio cells in a first set, but not a second set;
means for using the radio measurements to obtain a prediction of availability, for connection, of the second set of radio cells, wherein the first set of radio cells and the second set of radio cells are distinct having no cells in common; and
means for, in dependence upon the prediction, making radio measurements for connection to a radio cell in the second set.

In some but not necessarily all examples, the user equipment comprises means for skipping or suspending making some or all radio measurements for radio cells of the second set until a radio cell of the second set is predicted as available for connection and then making radio measurements for the radio cell of the second set predicted as available.

In some but not necessarily all examples, the user equipment comprises means for enabling use of the radio measurements for radio cells in the first set as input to a trained machine learning model trained to predict availability, for connection, of the second set of radio cells.

In some but not necessarily all examples, the trained machine learning model is comprised in the user equipment.

In some but not necessarily all examples, the user equipment comprises means for providing labeled training data for training the machine learning model at a network node, wherein the labeled training data comprises radio measurements for multiple cells in the first set labelled explicitly or implicitly, using availability of the second set of cells for contemporaneous connection by the user equipment.

In some but not necessarily all examples, the user equipment comprises means for making radio measurements for radio cells, including a primary radio cell and one or more neighboring cells, in the first set when the user equipment is at the primary radio cell of the first set; and
means for using the radio measurements to obtain a prediction of availability, for connection, of the user equipment at the primary radio cell, to a second set of radio cells.

In some but not necessarily all examples, the first set of radio cells operate at a first frequency range and the second set of radio cells operate at a second frequency range, non-overlapping the first frequency range and wherein the radio measurements for radio cells in the first set are measured in the first frequency range not the second frequency range.

In some but not necessarily all examples, the first set of radio cells operate using a first radio access technology and the second set of radio cells operate using a second radio access technology, different to the first radio access technology and wherein the radio measurements for radio cells in the first set are measured using the first radio access technology not the second radio access technology.

In some but not necessarily all examples, the first set of radio cells operate within a first macro layer and the second set of radio cells operate within a second micro layer, different to and partially physically overlapping the first macro layer, wherein the first macro layer comprises radio cells that physically overlap to blanket cover a first area and wherein the second micro layer comprises one or more isolated, non-overlapping, clusters of one or more radio cells that, in combination, only partially cover the first area.

In some but not necessarily all examples, the first set of radio cells operate within a first coverage layer and the second set of radio cells operate within a second capacity layer, different to and partially overlapping in space the first coverage layer, wherein the coverage layer is configured for larger area coverage at lower quality of service and the second capacity layer is configured for relatively smaller area coverage at relatively higher quality of service.

In some but not necessarily all examples, the user equipment comprises means for making radio measurements for the radio cell of the second set predicted as available for connection, and in dependence upon the radio measurements for the radio cell of the second set subsequently changing a serving radio cell of the user equipment from a radio cell in the first set to a radio cell in the second set.

According to various, but not necessarily all, examples there is provided a system comprising: the user equipment; and
a network node, wherein the user equipment is configured to provide the radio measurements for radio cells in the first set to the network node, and
wherein the network node comprises means for using the provided radio measurements for radio cells in a first set to enable prediction of availability, for connection, of the second set of radio cells.

According to various, but not necessarily all, examples there is provided a method comprising:
making radio measurements for radio cells in a first set, but not a second set;
using the radio measurements to obtain a prediction of availability, for connection, of the second set of radio cells, wherein the first set of radio cells and the second set of radio cells are distinct having no cells in common; and
in dependence upon the prediction, making radio measurements for connection to a radio cell in the second set.

According to various, but not necessarily all, examples there is provided a computer readable media comprising program instructions that, when executed by one or more processors, cause the one or more processors to perform:
making radio measurements for radio cells in a first set, but not a second set;
using the radio measurements to obtain a prediction of availability, for connection, of the second set of radio cells, wherein the first set of radio cells and the second set of radio cells are distinct having no cells in common; and
in dependence upon the prediction, making radio measurements for connection to a radio cell in the second set.

According to various, but not necessarily all, examples there is provided a network node comprising means for
using radio measurements for radio cells in a first set to enable prediction of availability, for connection, of a second set of radio cells, wherein the first set of radio cells and the second set of radio cells are distinct having no cells in common.

In some but not necessarily all examples, the radio measurements are user equipment radio measurements received from user equipment.

In some but not necessarily all examples, the network node comprises means for using the radio measurements for radio cells in the first set to train a machine learning model to predict availability, for connection, of the second set of radio cells. In some but not necessarily all examples, the network node comprises means for using radio measurements for radio cells, including a primary radio cell and possible one or more neighboring cells, in the first set made by user equipment at the primary radio cell of the first set, to enable prediction of availability, for connection by a user equipment at the primary radio cell, to a second set of radio cells.

In some but not necessarily all examples, the network node comprises means for training a machine learning model using labeled training data for supervised training of the machine learning model, wherein the labeled training data comprises radio measurements for multiple cells in the first set labelled explicitly or implicitly, using availability of the second set of cells for contemporaneous connection by the user equipment at the primary radio cell, wherein the trained machine learning model is thus configured to predict availability of the second set of cells for connection by a user equipment at the primary radio cell, in response to an input comprising radio measurements for multiple cells in the first set made by the user equipment at the primary radio cell.

In some but not necessarily all examples, the first set represents radio cells of a first radio access network layer and wherein the second set represents radio cells of a second radio access network layer distinct from the first radio access network layer. In some but not necessarily all examples, the network node comprises means for predicting availability to an arbitrary user equipment, for connection, of a second set of radio cells, in response to radio measurements from the arbitrary user equipment for radio cells in the first set.

In some but not necessarily all examples, the network node comprises means for receiving for each of multiple user equipment radio measurements for radio cells in the first set to enable prediction of availability, for connection, of the second set of radio cells.

In some but not necessarily all examples, the network node comprises
means for receiving for each of multiple radio cells in the first set,
radio measurements for radio cells in the first set to enable prediction of availability, for connection, of the second set of radio cells; and/or
comprises means for receiving over a range of times, a range of different radio cells of the first set, and a range of different UEs radio measurements for radio cells in the first set to enable prediction of availability, for connection, of the second set of radio cells.

According to various, but not necessarily all, examples there is provided a method comprising:
using radio measurements for radio cells in a first set to enable prediction of availability, for connection, of a second set of radio cells, wherein the first set of radio cells and the second set of radio cells are distinct having no cells in common.

According to various, but not necessarily all, examples there is provided a computer readable medium comprising program instructions that, when executed by one or more processors, cause the one or more processors to perform:
using radio measurements for radio cells in a first set to enable prediction of availability, for connection, of a second set of radio cells, wherein the first set of radio cells and the second set of radio cells are distinct having no cells in common.

According to various, but not necessarily all, examples there is provided an apparatus comprising at least one processor, and at least one memory storing instructions that, when executed by the at least one processor, cause the apparatus to perform: making radio measurements for radio cells in a first set, but not a second set; using the radio measurements to obtain a prediction of availability, for connection, of the second set of radio cells, wherein the first set of radio cells and the second set of radio cells are distinct having no cells in common; and in dependence upon the prediction, making radio measurements for connection to a radio cell in the second set.

According to various, but not necessarily all, examples there is provided an apparatus comprising at least one processor, and at least one memory storing instructions that, when executed by the at least one processor, cause the apparatus to perform: using radio measurements for radio cells in a first set to enable prediction of availability, for connection, of a second set of radio cells, wherein the first set of radio cells and the second set of radio cells are distinct having no cells in common.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION Some examples will now be described with reference to the accompanying drawings in which:

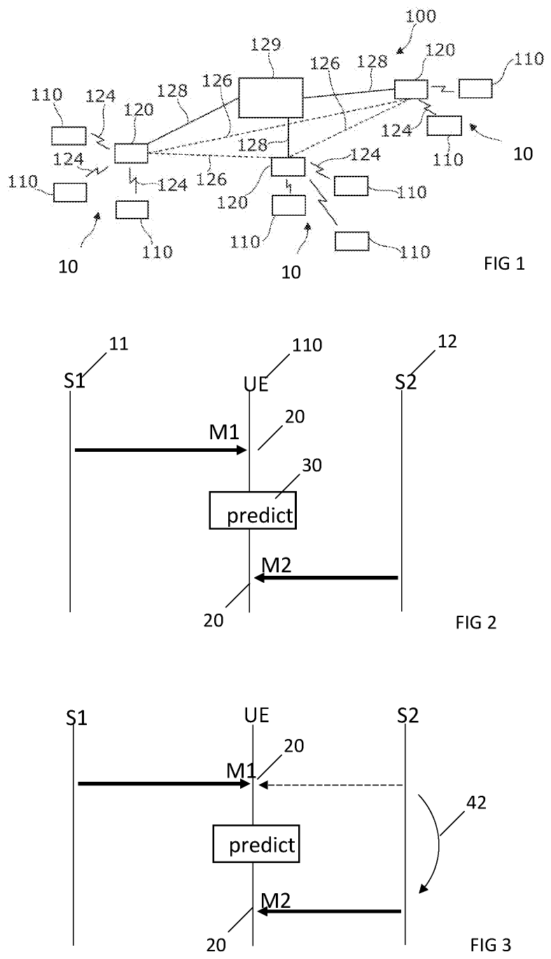

FIG. 1 shows an example of the subject matter described herein;

FIG. 2 shows another example of the subject matter described herein;

FIG. 3 shows another example of the subject matter described herein;

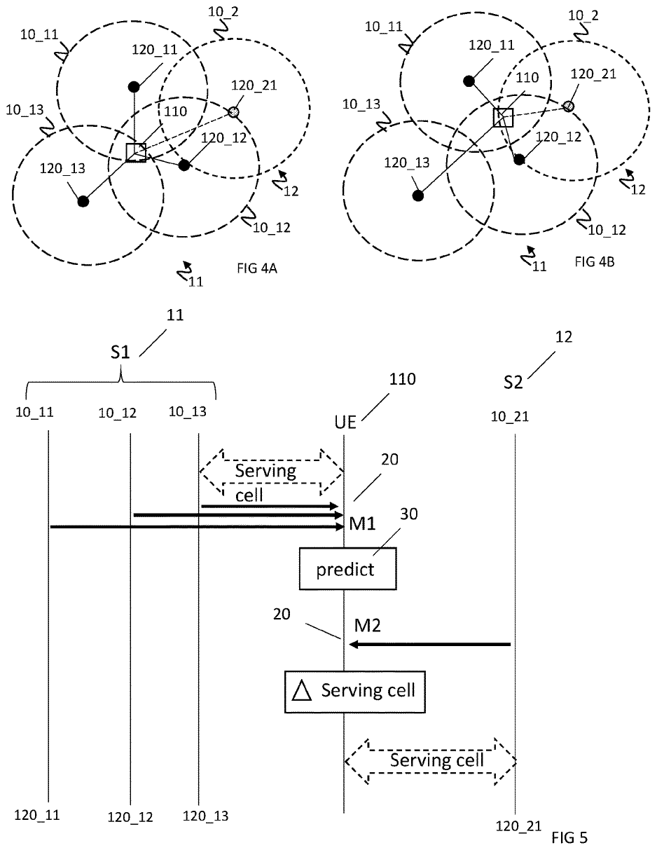

FIG. 4A shows another example of the subject matter described herein;

FIG. 4B shows another example of the subject matter described herein;

FIG. 5 shows another example of the subject matter described herein;

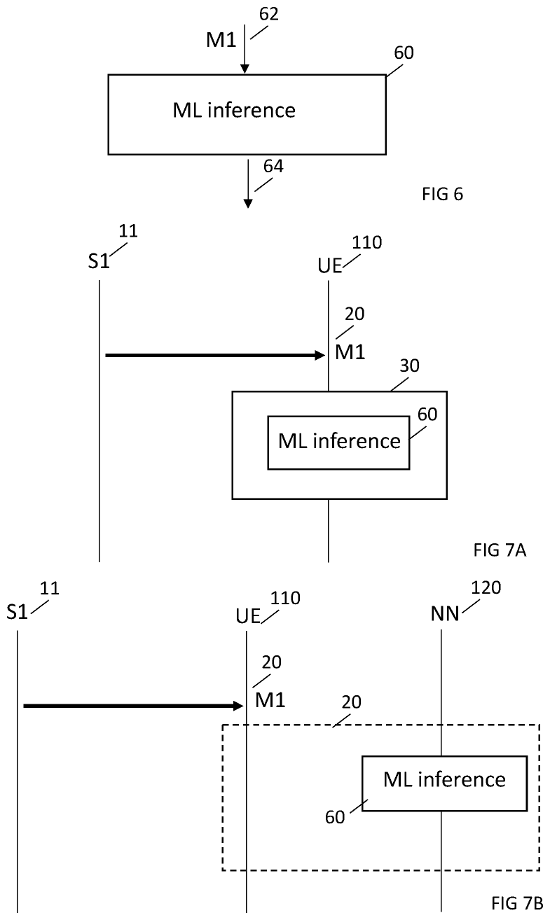

FIG. 6 shows another example of the subject matter described herein;

FIG. 7A shows another example of the subject matter described herein;

FIG. 7B shows another example of the subject matter described herein;

FIG. 8 shows another example of the subject matter described herein;

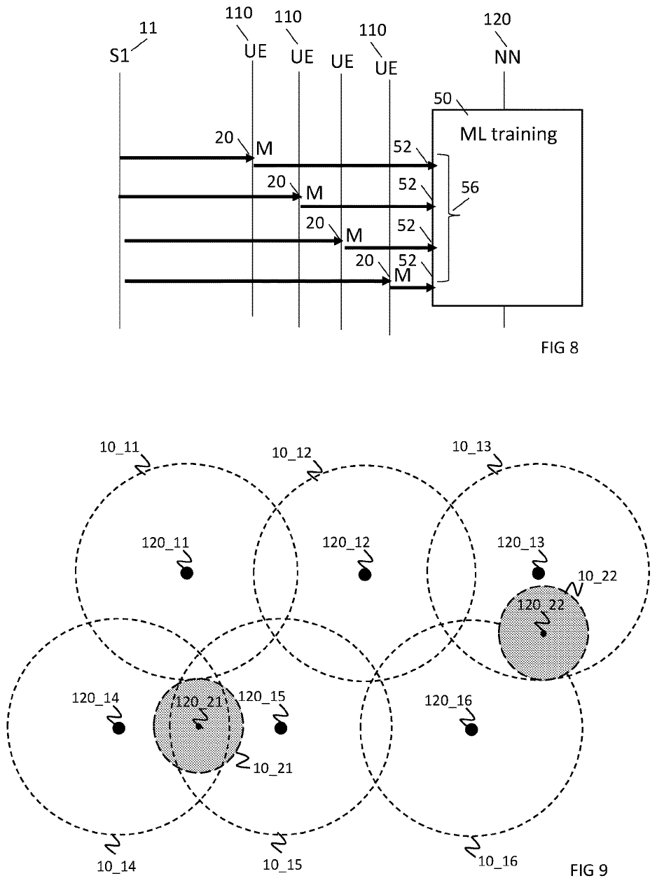

FIG. 9 shows another example of the subject matter described herein;

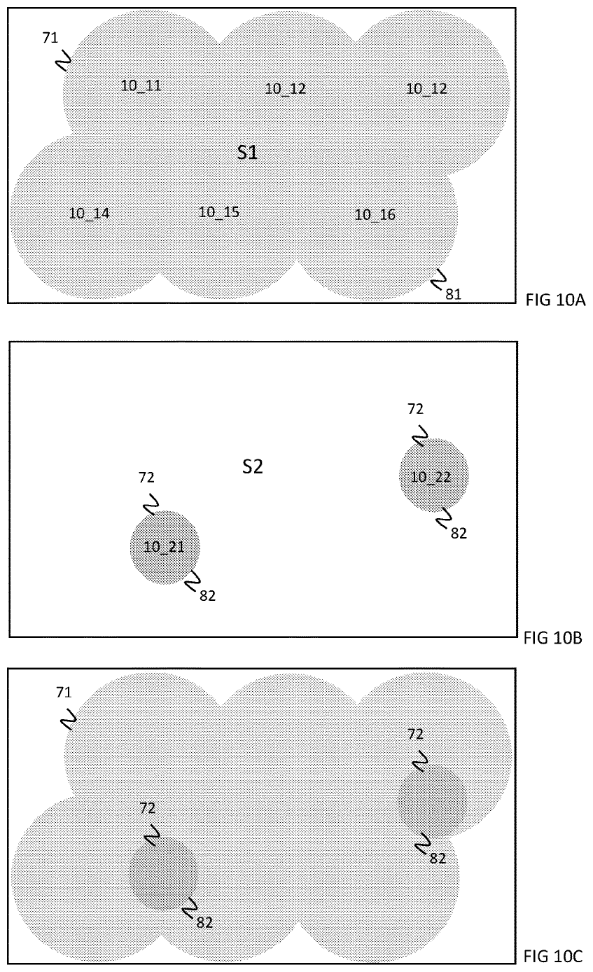

FIG. 10A shows another example of the subject matter described herein;

FIG. 10B shows another example of the subject matter described herein;

FIG. 10C shows another example of the subject matter described herein;

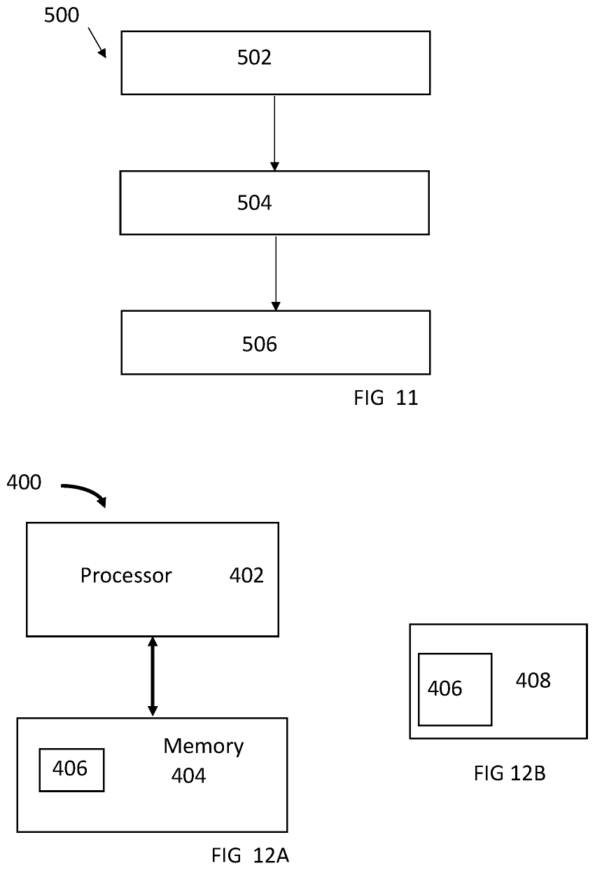

FIG. 11 shows another example of the subject matter described herein;

FIG. 12A shows another example of the subject matter described herein;

FIG. 12B shows another example of the subject matter described herein;

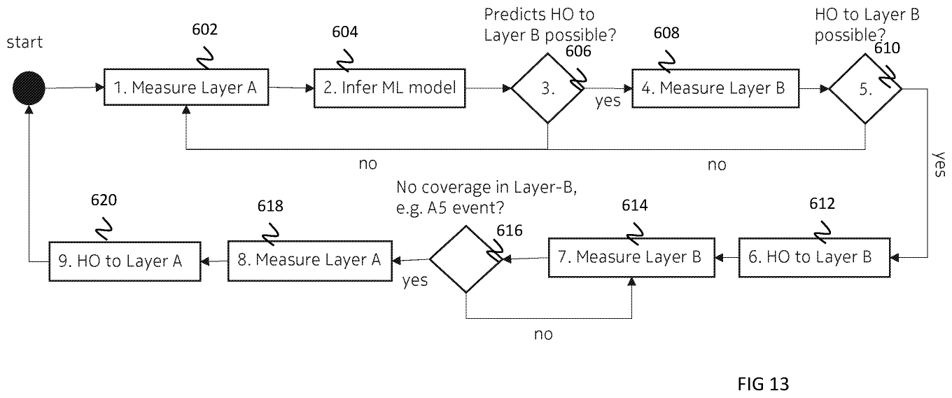

FIG. 13 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the following description a class (or set) can be referenced using a reference number without a subscript index (e.g. 10) and a specific instance of the class (member of the set) can be referenced using the reference number with a numerical type subscript index (e.g. 10_1) and a non-specific instance of the class (member of the set) can be referenced using the reference number with a variable type subscript index (e.g. 10_i).

### DETAILED DESCRIPTION

FIG. 1 illustrates an example of a network 100 comprising a plurality of network nodes including terminal nodes 110, access nodes 120 and one or more core nodes 129.

The terminal nodes 110 and access nodes 120 communicate with each other. The one or more core nodes 129 communicate with the access nodes 120.

The network 100 is in this example a cellular radio telecommunications network, in which at least some of the terminal nodes 110 and access nodes 120 communicate with each other using transmission/reception of radio waves.

The one or more core nodes 129 may, in some examples, communicate with each other. The one or more access nodes 120 may, in some examples, communicate with each other.

The network 100 is a cellular network comprising a plurality of cells 10 each served by an access node 120. In this example, the interface between the terminal nodes 110 and an access node 120 defining a radio cell 10 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In the particular example illustrated the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio

Access network (NG-RAN). The NG-RAN consists of gNodeBs (gNBs) 120, providing the user plane and control plane (RRC) protocol terminations towards the UE 110.

The gNBs 120 are interconnected with each other by means of an X2/Xn interface 126. The gNBs are also connected by means of the N2 interface 128 to the Access and Mobility management Function (AMF).

A user equipment comprises a mobile equipment. Where reference is made to user equipment that reference includes and encompasses, wherever possible, a reference to mobile equipment.

The following examples relate to a user equipment 110 comprising:
means for making radio measurements 20 for radio cells 10 in a first set (S1), but not a second set (S2);
means for using the radio measurements 20 to obtain a prediction 30 of availability, for connection, of the second set (S2) of radio cells 10, wherein the first set (S1) of radio cells 10 and the second set (S2) of radio cells 10 are distinct having no radio cells 10 in common; and
means for, in dependence upon the prediction 30, making radio measurements 20 for connection to a radio cell 10 in the second set (S2).

The following examples relate to a network node 120 comprising means for
using radio measurements 20 for radio cells 10 in a first set (S1) to enable prediction 30 of availability, for connection, of a second set (S2) of radio cells 10, wherein the first set (S1) of radio cells 10 and the second set (S2) of radio cells 10 are distinct having no cells in common.

FIG. 2 illustrates an example of user equipment 110.

The user equipment 110 is configured to make radio measurements (M1) 20 for radio cells 10 in a first set (S1) 11, but not a second set (S2) 12;
use those radio measurements 20 to obtain 30 a prediction of availability, for connection, of the second set (S2) 12 of radio cells 10; and
in dependence upon the prediction, make radio measurements 20 for connection to a radio cell 10 in the second set (S2) 12.

The first set (S1) 11 of radio cells 10 and the second set (S2) 12 of radio cells 10 are distinct having no radio cells 10 in common.

The likelihood of performing an unnecessary measurement for the second set (S2) 12 is therefore reduced.

FIG. 3 illustrates an example of user equipment 110 previously illustrated in FIG. 2.

In this example, the user equipment 110 would normally unconditionally make a radio measurement 20 for radio cells 10 of the second set (S2) 12 (illustrated with a dotted signal line) as well as unconditionally making a radio measurement 20 for radio cells 10 of the first set (S1) 11. However, the user equipment 110 is configured to make radio measurements (M) 20 for radio cells 10 in a first set (S1) 11, but not the second set (S2) 12.

The user equipment requires satisfaction of a condition before making the radio measurement 20 for radio cells 10 of the second set (S2) 12. This condition is dependent upon the prediction of availability, for connection, of the second set (S2) 12 of radio cells 10. For example, the user equipment 110 only makes the radio measurement 20 for radio cells 10 of the second set (S2) 12 if there is a predicted likelihood of availability, for connection, of the second set (S2) of radio cells 10.

The user equipment is configured 42 to skip or suspend making some or all radio measurements 20 for radio cells 10 of the second set (S2) 12 until a radio cell 10 of the second set (S2) 12 is predicted as available for connection and configured to the make radio measurements 20 for the radio cell 10 of the second set (S2) 12 predicted as available. In some examples, the user equipment is configured to skip or suspend making all radio measurements 20 for radio cells 10 of the second set (S2) 12 until a radio cell 10 of the second set (S2) 12 is predicted as available. In some examples, the user equipment is configured to making radio measurements 20 for radio cells 10 of the second set (S2) 12 less frequently until a radio cell 10 of the second set (S2) 12 is predicted as available.

The process for making the radio measurements 20 for radio cell 10 of the second set (S2) 12 as a result of the prediction is the same as the skipped process for making the radio measurements 20 for radio cell 10 of the second set (S2) 12. That i process is delayed, but not altered. It involves a survey of available radio cells of the second set (S2) 12. The survey of available radio cells of the second set (S2) 12 is not directed to a particular radio cell(s) by the prediction but is merely triggered (with conditional delay) by the prediction.

The likelihood of performing an unnecessary survey is therefore reduced.

FIGS. 4A and 4B illustrate the same radio cells 10 in the same arrangement but with different locations of the user equipment 110. Each of the radio cells 10 is associated with a base station 120.

The first set (S1) 11 of radio cells 10_1i comprises radio cell 10_11 controlled by base station 120_11, radio cell 10_12 controlled by base station 120_12, and radio cell 10_13 controlled by base station 120_13 (other cells, if any in the first set (S1) 11 are not illustrated).

The second set (S2) 12 of radio cells 10_2i comprises radio cell 10_2 controlled by base station 120_2 (other cells, if any in the second set (S2) 12 are not illustrated).

In both FIGS. the user equipment 110 is making of radio measurements 20 for radio cells 10_1i in the first set (S1) 11. This produces a first set of measurements 20 represented by the arrangement of solid lines emanating from the user equipment 110 towards the base stations 120_1i associated with the first set (S1) 11 of radio cells 10_1.

In both FIGS. the user equipment 110 is not making radio measurements for the radio cells 10_2i in the second set (S2) 12. The absence of measurements is represented by the dotted line between the user equipment 110 and the base station(s) 120_2 associated with the second set (S2) 12 of radio cells 10_2.

The pattern of radio measurements 20 for radio cells 10_1i in the first set (S1) 11 has a form that depends upon the location (and radio environment) of the user equipment 110. It changes between FIGS. 4A and 4B, which illustrate the corresponding changing arrangement of solid lines emanating from the user equipment 110 towards the base stations 120_1i associated with the first set (S1) 11 of radio cells 10_1.

Any radio measurements for a radio cell 10_2 in the second set (S2) 12 will also depend upon the location (and radio environment) of the user equipment 110.

Therefore the pattern of radio measurements 20 for radio cells 10_1i in the first set (S1) 11 can be used to predict an expected radio measurement for a radio cell 10_2 in the second set (S2) 12 and hence predict an availability of that radio cell 10_2i for radio connection to the user equipment 10.

The radio measurement 20 can, for example, comprise a measured value of at least one parameter for a radio cell. This can, for example be a radio link parameter such as radio signal strength and/or quality measurements (e.g. reference signal received power RSRP, signal to interference noise ratio SINR etc.).

The radio measurement 20 for a radio cell 10 can for example be based upon a measurement made of a reference signal transmitted by a base station 120 associated with the radio cell 10.

The radio measurement 20 can, for example, be a mobility-related measurement (Layer 3). Handover to and from a radio cell is controlled by protocol layer 3 mobility management signaling. A cell may be covered by a number of beams controlled by protocol layer-1 and protocol layer-2 signaling. Traffic steering between different frequency layers or RATs happens on protocol layer-3.

FIG. 5 illustrates an example of user equipment 110 previously illustrated in FIG. 2.

The user equipment 110 is configured to make radio measurements (M1) 20 for radio cells 10_1i in a first set (S1) 11, but not a second set (S2) 12.

In this example, user equipment 110 is configured to make one or more radio measurements 20 for the radio cell 10_11 in the first set (S1) 11, one or more radio measurements 20 for the radio cell 10_12 in the first set (S1) 11, and one or more radio measurements 20 for the radio cell 10_13 in the first set (S1) 11.

In some examples, the user equipment 110 is configured to make one or more radio measurements 20 for the radio cell 10_11 in the first set (S1) 11 by measuring a reference signal transmitted by the base station 120_11 associated with the radio cell 10_11, one or more radio measurements 20 for the radio cell 10_12 in the first set (S1) 11 by measuring a reference signal transmitted by the base station 120_12 associated with the radio cell 10_12, and one or more radio measurements 20 for the radio cell 10_13 in the first set (S1) 11 by measuring a reference signal transmitted by the base station 120_13 associated with the radio cell 10_13, The user equipment 110 is configured to use those radio measurements 20 (the radio measurements 20 for radio cells 10_1i in the first set (S1) 11, but not a second set (S2) 12) to obtain a prediction 30 of availability, for connection, of the second set (S2) 12 of radio cells 10. This is a prediction of availability (for handover) of a base station associated with a radio cell of the second set.

The prediction is a prediction of availability of the second set for connection. It is not an identification of a particular radio cell of the second set. The subsequent measurement determines availability of a particular radio cell of the second set.

The user equipment 110 is configured to, in dependence upon the prediction, make radio measurements (M2) 20 for connection to a radio cell 10 in the second set (S2) 12.

For an unfavorable prediction or set of predictions, the user equipment 110 does not make radio measurements (M2) 20 for connection to a radio cell 10 in the second set (S2) 12.

For a favorable prediction or set of predictions, the user equipment 110 does make radio measurements (M2) 20 for connection to a radio cell 10 in the second set (S2) 12.

The likelihood of performing an unnecessary measurement (M2) 20 is therefore be reduced. However, measurement (M2) 20 is still performed and not avoided, but it is now conditionally performed in dependence upon the prediction.

In at least some examples, the user equipment 110 is configured to make radio measurements 20 for the radio cell(s) 10 of the second set (S2) 12 predicted as available for connection.

The user equipment 110 is configured to change the serving radio cell 10 of the user equipment 110 from a radio cell 10 in the first set (S1) 11 to a radio cell 10 in the second set (S2) 12 in dependence upon the radio measurements 20 for the radio cell 10 of the second set (S2) 12. This is illustrated in FIG. 5. The FIG illustrates that before (and during) the period when the user equipment 110 makes radio measurements (M) 20 for radio cells 10_1i in the first set (S1) 11, but not a second set (S2) 12, the user equipment 110 is connected (e.g. RRC connected) to the radio cell 10_11 of the first set 11 of radio cells 10_1i. The FIG illustrates that after making the subsequent radio measurements (M) 20 for radio cells 10_2i in the second set (S2) 12, in dependence on the prediction, the user equipment 110 changes its serving cell from the radio cell 10_11 of the first set 11 to the radio cell 12_21 of the second set 12. This can, for example, be achieved by a network controlled or user equipment assisted handover. The FIG illustrates that after making the subsequent radio measurements (M2) 20 for radio cells 10_2i in the second set (S2) 12, in dependence on the prediction, the user equipment changes its serving cell from the radio cell 10_13 of the first set 11 to the radio cell 12_21 of the second set 12. The user equipment 110 is therefore configured to change (directly or indirectly) the serving radio cell 10 of the user equipment 110 from a radio cell 10 in the first set (S1) 11 to a radio cell 10 in the second set (S2) 12 in dependence upon the radio measurements 20 for the radio cell 10 of the second set (S2) 12.

The change in the serving radio cell can be as a result of normal handover (decision at the network) or conditional handover (a decision at UE). It can also occur during a set-up of dual connectivity or carrier aggregation.

Since the output of the prediction model is not used directly for handover but is used indirectly to measure for handover, the cost of a false positive prediction is only that a single unnecessary measurement M2 is taken, which would have been taken anyway if not skipped, if there was no suspension 42. The cost of a false negative is that the UE 110 will not handover when it would be able to do so. In this case, the UE 110 may handover in a subsequent measurement (M2), when the model predicts a true positive. Alternatively, the UE 110 can measure with a given probability even in case the model output is negative, to account for situations, where the model is consistently predicting false negatives in some circumstances. A further embodiment may be to follow a relaxed periodic inter-layer measurement when the model prediction is negative.

FIG. 6 illustrates an example of a trained machine learning model 60. This can, for example, be any suitable machine learning model that can recognize patterns produced by the sets of radio measurements 20 for radio cells 10 in a first set (S1) 11, but not a second set (S2) 12, and associate them with an indication (prediction) of availability of for connection, of the second set (S2) 12 of radio cells 10.

This can, for example, be achieved by supervised training a machine learning model to produce the trained machine learning model 60. The supervised training, labels the training data (the sets of radio measurements 20 for radio cells 10 in a first set (S1) 11, but not a second set (S2) 12 which represent the patterns for recognition) explicitly or implicitly with an indication (prediction) of availability for connection, of the second set (S2) 12 of radio cells 10. An explicit label can, for example, provide a non-binary confidence level for availability. An implicit label can involve providing training data only for where a confidence level for availability is above (or below) a threshold or where a binary confidence level has one specific value only.

In some examples, the training data for training can be augmented with additional parameters that reduce a search space. Examples include ordering or augmenting the training data systematically based on cell identification and/or location. Examples include augmenting the training data with identifiers of the radio cells 10_1 of the first set associated with the respective measurements (M1) 20. The training data would then comprise for each label additional data identifying the radio cells 10_1 in the first set 11 contributing the measurements (M1) 20 or which cell 10_1i of the first set 11 contributes each separate measurement (M2) 20. Other examples include augmenting the training data with a location of the user equipment and/or an identity of a serving cell.

Artificial neural networks can provide suitable machine learning models 60. Radio measurements 20 are affected by many factors some of which cannot be accounted for (temporary interference, for example) and artificial neural networks handle this uncertainty well. The artificial neural network can for example be a back-propagation, feed-forward artificial neural network

In at least some examples, the user equipment 110 is configured to enable use of the radio measurements 20 for radio cells 10 in a first set (S1) 11 (not the second set (S2) 12) as input to a trained machine learning model 60 trained to predict availability, for connection, of the second set (S2) 12 of radio cells 10. The prediction can be a binary prediction 30 (SoftMax) or a probability/confidence

FIG. 7A illustrates an example where the trained machine learning model 60 is comprised in the user equipment 110. The trained machine learning model 60 is local. The user equipment 110 is configured to use the radio measurements (M1) 20 for radio cells 10 in a first set (S1) 11 (not the second set (S2) 12) as input to the local trained machine learning model 60 to locally predict availability, for connection, of the second set (S2) 12 of radio cells 10. As previously described, in dependence upon the prediction, the user equipment 110 makes radio measurements (M2) 20 for connection to a radio cell 10 in the second set (S2) 12.

FIG. 7B illustrates an example where the trained machine learning model 60 is not comprised in the user equipment 110 but is comprised in a remote network node 120. The trained machine learning model 60 is remote. The user equipment 110 is configured to send the radio measurements (M1) 20 for radio cells 10 in a first set (S1) 11 (not the second set (S2) 12) to the network node 120 for input to the remote trained machine learning model 60. The remote trained machine learning model 60 is configured to predict availability, for connection, of the second set (S2) 12 of radio cells 10 and can send this prediction back to the user equipment 110. As previously described, in dependence upon the prediction, the user equipment 110 makes radio measurements (M2) 20 for connection to a radio cell 10 in the second set (S2) 12.

FIG. 8 illustrates an example of the training of a machine learning model 50 to obtain the trained machine learning model 60 (not illustrated in the FIG).

In this example, the machine learning model 50 is trained using supervised training to produce the trained machine learning model 60.

The supervised training uses labelled training data 56. The training data (the measurements 20 of the type that will be used in the future as input to the trained machine learning model 60) are labelled with labels (the outputs that are in the future desired from the trained machine learning model 60 in response to that input. The labels can be applied by the user equipment 110 or by the network node 120.

The training data (the sets of radio measurements 20 for radio cells 10 in a first set (S1) 11, but not a second set (S2) 12 which represent the patterns for recognition) are explicitly or implicitly labelled with an indication (prediction) of availability for connection, of the second set (S2) 12 of radio cells 10.

An explicit label can, for example, provide a non-binary confidence level for availability. An implicit label can involve providing training data only for where a confidence level for availability is above (or below) a threshold or where a binary confidence level has one specific value only. Thus “implicitly” can refer to a binary classifier where only one class of training data is used for training, so that provision of radio measurements 20 for multiple cells in the first set (S1) 11 implies availability of the second set (S2) 12 of cells for contemporaneous connection by the user equipment 110.

Thus, the radio measurements 20 for radio cells 10 in the first set (S1) 11 train a machine learning model 50, at a network node, to predict availability, for connection, of the second set (S2) 12 of radio cells 10.

The machine learning model 50 is trained using the radio measurements 20 for radio cells 10 in the first set (S1) 11 made by multiple different user equipment as illustrated in FIG. 8.

In at least some examples, the user equipment 110 is configured to provide labeled training data 56 for training the machine learning model 50 at a network node 120, wherein the labeled training data 56 comprises radio measurements 20 for multiple cells in the first set (S1) 11 labelled 52 explicitly or implicitly, using availability of the second set (S2) 12 of cells for contemporaneous connection by the user equipment 110.

The network node is configured to use the provided radio measurements 20 for radio cells 10 in a first set (S1) 11 to train the machine learning model and thus enable prediction 30 of availability, for connection, of the second set (S2) 12 of radio cells 10.

In order to improve results, in at least some examples, a different machine learning model 50 is trained for each serving cell of the first set (S1) 11. The serving-cell specific machine learning model 50 is trained using the radio measurements 20 for radio cells 10 in the first set (S1) 11 made by multiple different user equipment 110 connected to the specific serving cell but not other serving cells.

The connection to a serving cell occurs, in 3GPP, when a user equipment 110 is in connected mode and is RRC connected to the serving cell.

However, in 3GPP, a user equipment 110 can be in other modes (idle, inactive) and is not RRC connected to the serving cell. However, in some circumstances measurements 20 by the user equipment 110 are possible to a radio cell 10 that is not a serving cell but is a possible future serving cell (a service cell). A primary-cell specific machine learning model 50 can therefore be trained for each primary cell of the first set (S1) 11 to obtain a primary-cell-specific-trained machine learning model 50. In some examples, a radio cell is a primary radio cell only if it is a serving cell. In some examples, a radio cell is a primary radio cell only if it is a serving cell or a service cell. The primary-cell specific machine learning model 50 is trained using the radio measurements 20 for radio cells 10 in the first set (S1) 11 made by multiple different users at the specific primary cell but not other primary cells.

Therefore, in at least some examples, the user equipment 110 is configured to make radio measurements 20 for radio cells 10, including a primary radio cell and one or more neighboring cells, in the first set (S1) 11 when the user equipment 110 is at the primary radio cell of the first set (S1) 11 and is configured to use the radio measurements 20 to obtain a prediction 30 of availability, for connection, of the user equipment 110 at the primary radio cell, of a second set (S2) 12 of radio cells 10. The user equipment then, in dependence upon the prediction, makes radio measurements (M2) 20 for connection to a radio cell 10 in the second set (S2) 12.

The prediction can be performed by a primary-cell-specific-trained machine learning model 50 configured to predict availability of the second set (S2) 12 of cells for connection by the user equipment 110 at the primary radio cell, in response to an input comprising radio measurements 20 for multiple cells in the first set (S1) 11 made by the user equipment 110 at the primary radio cell.

In some examples, the measurements 20 used to train the neural network and used as query inputs for the trained neural network 60 comprise a measured value of at least one parameter for multiple radio cells 10 in a first set (S1) 11.

It is quite possible for a primary radio cell signal to be and remain strong but for a handover to the second set (S2) 12 to be preferred because the second set 12 of cells 10 has attributes that are preferred over the first set 11 of cells 10.

FIGS. 9 and 10A, 10B, 10C illustrate examples of a first set (S1) 11 of radio cells 10 and a second set (S2) 12 of radio cells 10.

The radio cells 10 have the same arrangement in the FIGS.. Each of the radio cells 10 is associated with a base station 110. The first set (S1) 11 of radio cells 10_1i comprises radio cell 10_11 controlled by base station 120_11, radio cell 10_12 controlled by base station 120_12, radio cell 10_13 controlled by base station 120_13, radio cell 10_14 controlled by base station 120_14, radio cell 10_15 controlled by base station 120_15 and radio cell 10_16 controlled by base station 120_16 (other cells, if any in the first set (S1) 11 are not illustrated).

The second set (S2) 12 of radio cells 10_2i comprises radio cell 10_21 controlled by base station 120_21 and radio cell 10_22 controlled by base station 120_22 (other cells, if any in the second set (S2) 12 are not illustrated).

In some examples, the first set (S1) 11 of radio cells 10 operate at a first frequency range and the second set (S2) 12 of radio cells 10 operate at a second frequency range, non-overlapping the first frequency range. The radio measurements (M1) 20 for radio cells 10 in the first set (S1) 11 are measured in the first frequency range not the second frequency range. The prediction-dependent, conditional radio measurements (M2) 20 for radio cells 10 in the second set (S2) 12 are measured in the second frequency range not the first frequency range.

There is a conditional delay in making measurements (M2) 20 for multiple cells 10 in the second set 12 based on a prediction of availability for connection. This avoids unnecessary inter-frequency measurement (different radio cells). Inter-frequency measurements can be costly because the user equipment 110 may need to reconfigure its transceiver to another frequency, which may cause for example service interruption time. If the user equipment 110 has several transceivers, then an additional transceiver needs to be activated to take measurements, which increases the energy consumption and reduces battery life.

In some examples, the first set (S1) 11 of radio cells 10 operate using a first radio access technology and the second set (S2) 12 of radio cells 10 operate using a second radio access technology, different to the first radio access technology. The radio measurements 20 for radio cells 10 in the first set (S1) 11 are measured using the first radio access technology not the second radio access technology. The prediction-dependent, conditional radio measurements (M2) 20 for radio cells 10 in the second set (S2) 12 are measured using the second radio access technology not the first radio access technology. The first radio access technology and the second first radio access technology operate in different, non-overlapping frequency ranges. In some examples, the first set (S1) 11 of radio cells 10 operate within a first macro layer 71 (FIG. 10A) and the second set (S2) 12 of radio cells 10 operate within a second micro layer 72 (FIG. 10B), different to the first macro layer 71 but partially physically overlapping the first macro layer (FIG. 10C). The first macro layer 71 comprises radio cells 10 that physically overlap to blanket cover a first area (FIGS. 10A, 10C). The second micro layer 72 comprises one or more isolated, non-overlapping, clusters of one or more radio cells 10 that, in combination, only partially cover the first area (FIGS. 10B, 10C).

In at least some examples, the first macro layer 71 operates as a first radio access network (RAN) layer with a first frequency range, and the second micro layer 72 operates as a second RAN layer with a second frequency range. The first frequency range and the second frequency range do not overlap and they may be is separate bands. The first and second RAN layers can use the same radio access technology (RAT) or different RAT.

The user equipment 110 can be configured to provide, at a series of different times or locations, radio measurements 20 for radio cells 10 in the first set (S1) 11 as an input to a trained machine learning model 60 trained to predict availability of a radio cell 10 of the second set (S2) 12 for connection, where the trained machine learning model 60 identifies a time or location when a radio cell of the second set (S2) 12 becomes suitable for use (connection) because the user equipment 110 has crossed an edge of the micro layer 72.

The user equipment 110 can be configured to provide, at a series of different times or locations, a measured value of at least one parameter for a primary radio cell as an input to a trained machine learning model 60 trained to predict availability of a radio cell of the second set (S2) 12 suitable for use, where the trained machine learning model 60 identifies a time or location when a radio cell of the second set (S2) 12 becomes suitable for use (connection) because the user equipment 110 at the primary cell has crossed an edge of the micro layer 72.

In some examples, the first set (S1) 11 of radio cells 10 operate within a first coverage layer 81 (FIG. 10A) and the second set (S2) 12 of radio cells 10 operate within a second capacity layer 82 (FIG. 10B), different to the first coverage layer 81 but partially physically overlapping the first coverage layer 81 (FIG. 10C). The coverage layer 81 is configured for larger area coverage at lower quality of service and the second capacity layer is configured for relatively smaller area coverage at relatively higher quality of service. The current QoS can be for example throughput or best available QoS, for example, e.g. bandwidth.

In the example illustrated, but not necessarily all examples, the first coverage layer 81 comprises radio cells 10 that physically overlap to blanket cover a first area (FIGS. 10A, 10C). The second capacity layer 82 comprises one or more isolated, non-overlapping, clusters of one or more radio cells 10 that, in combination, only partially cover the first area (FIGS. 10B, 10C).

FIG. 11 illustrates an example of a method 500.

At block 502, the method 500 comprises making radio measurements 20 for radio cells 10 in a first set (S1) 11, but not a second set (S2) 12.

At block 502, the method 500 comprises using the radio measurements 20 from block 502 to obtain a prediction of availability, for connection, of the second set (S2) 12 of radio cells 10, wherein the first set (S1) 11 of radio cells 10 and the second set (S2) 12 of radio cells 10 are distinct having no cells in common.

At block 502, the method 500 comprises, in dependence upon the prediction, making radio measurements 20 for connection to a radio cell 10 in the second set (S2) 12.

In at least some examples the method 500 is performed by the user equipment 110. In at least some examples the method 500 is performed automatically by the user equipment 110. In at least some examples, some or all of the blocks 502, 504, 506 are performed automatically by the user equipment 110. In at least some examples, block 504 is performed automatically after block 502. In at least some examples, block 506 is performed automatically after block 504.

The term automatic means that the action occurs without any contemporaneous user input being required from a user of the user equipment 110.

A particular example of automatic performance is autonomous performance. In autonomous examples, the action (e.g. blocks 502, 504, 506) occur without any real-time user input being required from a user of the user equipment 110 or any real-time commands being required from the network. The network may have preconfigured the action but its timely input is not required to trigger the action.

Referring back to FIG. 8 in some examples, the network node 120 configured to use radio measurements 20 for radio cells 10 in a first set (S1) 11 to enable prediction of availability, for connection, of a second set (S2) 12 of radio cells 10, wherein the first set (S1) 11 of radio cells 10 and the second set (S2) 12 of radio cells 10 are distinct having no cells in common. The network node is used to train a machine learning model 50 to create a trained machine learning model used to predict availability, for connection, of a second set (S2) 12 of radio cells 10, wherein the first set (S1) 11 of radio cells 10 and the second set (S2) 12.

In these examples, as illustrated in FIG. 8, the network node 120 is configured to use the radio measurements 20 for radio cells 10 in the first set (S1) 11 to train a machine learning model 50 to produce the trained machine learning model 60 configured to predict availability, for connection, of the second set (S2) 12 of radio cells 10. The labeled training data comprises radio measurements 20 for multiple cells in the first set (S1) 11 labelled explicitly or implicitly, using availability of the second set (S2) 12 of cells for contemporaneous connection by the user equipment 110. The trained machine learning model 60 is thus configured to predict availability of the second set (S2) 12 of cells for connection by a user equipment 110, in response to an input comprising radio measurements 20 for multiple cells in the first set (S1) 11.

In some examples, the network node 120 is configured to use radio measurements 20 for radio cells 10, including a primary radio cell and one or more neighboring cells, in the first set (S1) 11 made by user equipment 110 at the primary radio cell of the first set (S1) 11, to train a machine learning model and enable prediction of availability, for connection by a user equipment 110 at the primary radio cell, of a second set (S2) 12 of radio cells 10. The labeled training data comprises radio measurements 20 for multiple cells in the first set (S1) 11 labelled explicitly or implicitly, using availability of the second set (S2) 12 of cells for contemporaneous connection by the user equipment 110 at the primary radio cell. The trained machine learning model 60 is thus configured to predict availability of the second set (S2) 12 of cells for connection by a user equipment 110 at the primary radio cell, in response to an input comprising radio measurements 20 for multiple cells in the first set (S1) 11 (made by the user equipment 110 at the primary radio cell).

In some examples, the trained neural network model 60 is configured to predict availability to an arbitrary user equipment 110, for connection, of a second set (S2) 12 of radio cells 10, in response to radio measurements 20 from the arbitrary user equipment 110 for radio cells 10 in the first set (S1) 11. The neural network is not trained for a specific user equipment but is trained across multiple different user equipment 110. In at least some examples, the network node 120 is configured to receive for each of multiple user equipment 110 radio measurements 20 for radio cells 10 in the first set (S1) 11 to enable prediction 30 of availability, for connection, of the second set (S2) 12 of radio cells 10.

The trained neural network 60 may, however, have been trained for a specific primary cell. In this example the network node 120 is configured to train a machine learning model 50 using labeled training data 56 for supervised training of the machine learning model 50, wherein the labeled training data comprises radio measurements 20 for multiple cells in the first set (S1) 11 labelled explicitly or implicitly, using availability of the second set (S2) 12 of cells for contemporaneous connection by the user equipment 110 in the primary radio cell, wherein the trained machine learning model is thus configured to predict availability of the second set (S2) 12 of cells for connection by an arbitrary user equipment 110 at the primary radio cell, in response to an input comprising radio measurements 20 from the arbitrary user equipment 110 for multiple cells in the first set (S1) 11.

The network node can be configured to train a machine learning model using labeled training data for supervised training of the machine learning model, wherein the labeled training data comprises radio measurements 20 for multiple cells in the first set (S1) 11 labelled explicitly or implicitly, using availability of the second set (S2) 12 of cells for contemporaneous connection by each of multiple user equipment 110 in the primary radio cell, wherein the trained machine learning model is thus configured to predict availability of the second set (S2) 12 of cells for connection by a user equipment 110 at the primary radio cell, in response to an input comprising radio measurements 20 from the user equipment 110 for multiple cells in the first set (S1) 11.

In some examples the network node 120 is configured to receive for each of multiple radio cells 10 in the first set (S1) 11, radio measurements 20 for radio cells 10 in the first set (S1) 11 to enable prediction 30 of availability, for connection, of the second set (S2) 12 of radio cells 10. In some of these examples, the network node 120 is configured to train a separate machine learning model, for each of multiple radio cells 10 in the first set (S1) 11, using labeled training data for supervised training of the machine learning model, wherein the labeled training data comprises radio measurements 20 for multiple cells in the first set (S1) 11 labelled explicitly or implicitly, using availability of the second set (S2) 12 of cells for contemporaneous connection by user equipment 110 in the primary radio cell, wherein the trained machine learning model is thus configured to predict availability of the second set (S2) 12 of cells for connection by a user equipment 110 at the primary radio cell, in response to an input comprising radio measurements 20 from the user equipment 110 for multiple cells in the first set (S1) 11.

In some examples the network node 120 is configured to receive over range of times, a range of different radio cells 10 of the first set (S1) 11, and a range of different UEs radio measurements 20 for radio cells 10 in the first set (S1) 11 to enable prediction 30 of availability, for connection, of the second set (S2) 12 of radio cells 10.

In at least some examples, the network (or other system or apparatus) can perform a method comprising: using radio measurements 20 for radio cells 10 in a first set (S1) 11 to enable prediction 30 of availability, for connection, of a second set (S2) 12 of radio cells 10, wherein the first set (S1) 11 of radio cells 10 and the second set (S2) 12 of radio cells 10 are distinct having no cells in common. This can be achieved by training a machine learning model 50.

The radio measurements 20 used for training a machine learning model 50 are user equipment 110 radio measurements 20 received from user equipment 110 and, in some examples, comprise a measured value of the at least one parameter for multiple cells is the first set (S1) 11.

The training data (measurement s 20) can be received labelled (where labeling occurs at the user equipment) or labelling can occur at the network node 120.

The training data is not labelled or augmented with an identity of a cell of the second set (S2) 12.

The trained machine learning model does not identify a target radio cell in the second set, rather it indicates a desirability to make measurements for radio cells of the second set 12.

FIG. 12A illustrates an example of a controller 400 suitable for use in an apparatus such as the user equipment 110 or the network node 120. Implementation of a controller 400 may be as controller circuitry. The controller 400 may be implemented in hardware alone, have certain aspects in software including firmware alone or can be a combination of hardware and software (including firmware).

As illustrated in FIG. 12A the controller 400 may be implemented using instructions that enable hardware functionality, for example, by using executable instructions of a computer program 406 in a general-purpose or special-purpose processor 402 that may be stored on a computer readable storage medium (disk, memory etc.) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus when loaded into the processor 402. The computer program instructions, of the computer program 406, provide the logic and routines that enables the apparatus to perform the methods illustrated in the accompanying Figs. The processor 402 by reading the memory 404 is able to load and execute the computer program 406.

The apparatus 110 comprises:
at least one processor 402; and
   at least one memory 404 including computer program code,
   the at least one memory storing instructions that, when executed by the at least one processor 402, cause the apparatus at least to:
perform radio measurements 20 for radio cells 10 in a first set (S1) 11, but not a second set (S2) 12;
use the radio measurements 20 to obtain a prediction 30 of availability, for connection, of the second set (S2) 12 of radio cells 10, wherein the first set (S1) 11 of radio cells 10 and the second set (S2) 12 of radio cells 10 are distinct having no cells in common; and
in dependence upon the prediction 30, perform radio measurements 20 for connection to a radio cell 10 in the second set (S2) 12.

The apparatus 120 comprises:
at least one processor 402; and
   at least one memory 404 including computer program code,
   the at least one memory storing instructions that, when executed by the at least one processor 402, cause the apparatus at least to:
use radio measurements 20 for radio cells 10 in a first set (S1) 11 to enable prediction 30 of availability, for connection, of a second set (S2) 12 of radio cells 10,
wherein the first set (S1) 11 of radio cells 10 and the second set (S2) 12 of radio cells 10 are distinct having no cells in common.

As illustrated in FIG. 12B, the computer program 406 may arrive at the apparatus via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus may propagate or transmit the computer program 406 as a computer data signal.

Computer program instructions for causing an apparatus 110 to perform at least the following or for performing at least the following:
making radio measurements 20 for radio cells 10 in a first set (S1) 11, but not a second set (S2) 12;
using the radio measurements 20 to obtain a prediction 30 of availability, for connection, of the second set (S2) 12 of radio cells 10, wherein the first set (S1) 11 of radio cells 10 and the second set (S2) 12 of radio cells 10 are distinct having no cells in common; and
in dependence upon the prediction 30, making radio measurements 20 for connection to a radio cell 10 in the second set (S2) 12.

Computer program instructions for causing an apparatus 120 to perform at least the following or for performing at least the following:
using radio measurements 20 for radio cells 10 in a first set (S1) 11 to enable prediction 30 of availability, for connection, of a second set (S2) 12 of radio cells 10, wherein the first set (S1) 11 of radio cells 10 and the second set (S2) 12 of radio cells 10 are distinct having no cells in common.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/ dynamic/cached storage.

Although the processor 402 is illustrated as a single component/circuitry it may be implemented as one or more separate components/circuitry some or all of which may be integrated/removable. The processor 402 may be a single core or multi-core processor.

Let's assume a scenario, where we have two layers, Layer A and Layer B. Let's further assume that the Layer A is a macro cell layer offering full coverage, whereas Layer B is a capacity layer, which offers better network QOS, e.g., better throughput than Layer A. Layer B has a different frequency than Layer A and may also implement a different Radio Access Technology (RAT). Therefore, we have a situation, where
Layer B is the preferred layer to connect to, when possible
Layer B has limited coverage area, whereas Layer A provides the coverage

If we assume that the user equipment (UE) 110 is connected to the macro Layer A, it needs to take mobility-related measurements 20 of the serving cell 10 and the neighboring cells 10 in Layer A. Additionally, to know if the UE 110 would also be able to handover to the preferred capacity Layer B, it also needs to take measurements on its frequency and/or RAT. However, taking inter-frequency or inter-RAT measurements is considerably more costly in terms of UE energy consumption to the UE 110 than taking measurements on the serving cell's frequency and may even lead to short interruptions in the connection. Therefore, it would be desirably to reduce the need for taking such inter-layer measurements.

Therefore in some examples, a machine learning model is used to learn the correlation between the Layer-3 radio measurements 20 of the two RAN layers.

Predictions from a trained machine learning model are used to minimize the number of inter-layer measurements that need to be taken by the UE for inter-frequency or inter-RAT mobility.

The high-level process is as follows:
Configure UEs 110 to collect measurements from both layers;
Collect the measurements 20 to create a training dataset 56;
train a (binary) classifier 50 with Layer A measurements as input, if the radio conditions (RSRP, SINR) in Layer B are sufficient to do a handover (HO) to Layer B.
This implicitly labels the Layer A measurements 20.
The trained model is deployed to predict, if a UE would be able to handover to Layer-B.

A more detailed flow of the algorithm inferring the model is shown in FIG. 13. Note that for the sake of clarity, possible inter-layer handover events are excluded from the figure. The steps in the algorithm are:

At block 602, the UE 110 measures the serving cell and the neighbor cells in Layer A.

At block 604, the Layer A measurements 20 are given as input to the trained machine learning (ML) model 60.

At block 606 the trained ML model 60 predicts if the UE would be able to connect to Layer B.

At block 608, the trained ML model 60 predicts if the UE 110 would be able to connect to Layer B and if Layer B therefore should be measured.

The decision has two embodiments:
Embodiment A: If binary model prediction (e.g. after a SoftMax layer) suggests handing over to Layer-B is possible.
Embodiment B: Measure Layer-B with the probability that corresponds to the confidence of the prediction model that handing over to Layer-B is possible
If model predicts that a handover to Layer-B is possible, UE takes measurements of Layer B (RSRP, SINR).

At block 610, the UE 110 checks if the measurements confirm that a handover to Layer B is possible. If not, return to block 602.

If the Layer B measurements confirm that a handover to Layer B is possible, the handover is triggered at block 612.

Once on Layer B, at block 614, the UE 110 will revert back to the baseline method. Since Layer B is the preferred layer, the UE can remain measuring the (not on Layer B) until there is no more coverage available in Layer B, indicated, e.g., by an A5 event. This is illustrated at block 614, 616.

The at block 618 the UE 110 measures Layer A. At block 620 the UE 110 starts a handover to Layer A and the algorithm starts from beginning

In another embodiment, a second model instance may be trained in a similar way to predict possible handovers from Layer B to Layer A, in case neither of them offers complete coverage and full coverage is offered only jointly by the two layers.

Similarly, additional model instances may be introduced to accommodate for more than two layers.

Note that since the algorithm is not acting directly on the output of the prediction model, the cost of a false positive prediction is only that a single unnecessary inter-frequency measurement is taken, which would have been taken anyway, if the invention was not used. The cost of a false negative is that the UE will not handover to Layer B, when it would be able to do so. In this case, the UE may handover in a subsequent measurement, when the model predicts a true positive. Alternatively, the described Embodiment B enables the UE to measure Layer B with a given probability even in case the model output is negative, to account for situations, where the model is consistently predicting false negatives in some circumstances. A further embodiment may be to follow a relaxed periodic inter-layer measurement when the model prediction is negative.

In some examples, the UE can save up to 75% of the micro-cell RSRP measurements with a negligible loss in throughput (less than 1%). Or, with a 15% false positive rate, i.e., saving about 850% of the inter-frequency measurements, there is an average throughput loss of only roughly 5%. This trade-off between saving measurements and losing throughput can be controlled by adjusting the threshold of prediction, in the same way that binary classifiers trade-off true positive rate and false positive rate, which is done by tuning the probability threshold above which the predicted probability of the positive class can be considered a hard positive (i.e. 1), and below which it is considered a hard negative (i.e. 0).

The approach significantly reduce the number of costly inter-frequency, inter-RAT measurements required, while maintaining almost the same network QoS for the UE in a manner that is robust against any prediction inaccuracies.

It will be appreciated from the foregoing that in some examples, the user equipment 110 comprises:
means for making radio measurements 20 for radio cells 10 in a first set (S1) 11, but not a second set (S2) 12;
means 42 for skipping or suspending some or all radio measurements 20 for the second set (S2) 12, but not the first set (S1) 11, until the second set (S2) 12 is predicted as available for connection and then enabling radio measurements 20 for at least a radio cell 10 of the second set (S2) 12 predicted as available for connection.

It will be appreciated from the foregoing that in some examples, the network node 120 comprises:
means for instructing a user equipment 110 to while connected to a serving cell, measure a value of at least one parameter for a serving cell; and
while connected to a serving cell and not connected to a non-serving cell, skip or suspend 42 some or all measurements of a value of the at least one parameter for the non-serving cell until a non-serving cell is predicted as available and then measure the value of the at least one parameter for the non-serving cell predicted as available.

It will be appreciated from the foregoing that in some examples, the user equipment 110 comprises:
means for making radio measurements 20 for radio cells 10 in a first set (S1) 11;
means for making radio measurements 20 for radio cells 10 in a second set (S2) 12;
means for providing radio measurements 20 for radio cells 10 in the first set (S1) 11 and for radio cells 10 in the second set (S2) 12 as training data to a network node for training a machine learning model across multiple user equipment 110 to enable prediction 30 of availability, for connection, of the second set (S2) 12 of radio cells 10;
means for providing radio measurements 20 for radio cells 10 in the first set (S1) 11 and not radio cells 10 in the second set (S2) 12 as input data to a trained machine learning model, for receiving in reply a communication dependent upon a prediction 30 of availability, for connection, of the second set (S2) 12 of radio cells 10 made by the trained machine learning model, and for making and providing radio measurements 20 for radio cells 10 in the second set (S2) 12.

It will be appreciated from the foregoing that in some examples, the network node 120 comprises:
means for receiving from user equipment 110 radio measurements 20 for radio cells 10 in a first set (S1) 11 and for radio cells 10 in a second set (S2) 12 as training data for training a machine learning model across multiple user equipment 110 to enable prediction 30 of availability, for connection, of the second set (S2) 12 of radio cells 10;
means for receiving from a user equipment 110 radio measurements 20 for radio cells 10 in the first set (S1) 11 and not radio cells 10 in the second set (S2) 12 as input data to a trained machine learning model, for providing to the user equipment 110 a communication dependent upon a prediction 30 of availability, for connection, of the second set (S2) 12 of radio cells 10 made by the trained machine learning model.

It will be appreciated from the foregoing that in some examples, the network node 120 comprises:
means for obtaining labeled training data comprising:
data representing user equipment 110 measured values of at least one parameter for multiple cells, including a primary radio cell and one or more neighboring cells, in the first set (S1) 11 wherein the data is labelled explicitly or implicitly, using availability of a second set (S2) 12 of cells for contemporaneous use by the user equipment 110 in the primary radio cell; and
using the labeled training data for supervised training of a machine learning model, wherein the machine learning model predicts availability of the second set (S2) 12 of cells for use by a user equipment 110 in the primary radio cell, in response to an input comprising data representing a user equipment 110 measured value of the at least one parameter for multiple cells is the first set (S1) 11.

It will be appreciated from the foregoing that in some examples, the network node 120 comprises:
means for receiving for each of multiple user equipment 110, data representing a user equipment 110 measured value of at least one parameter for a serving cell of the user equipment 110 and data representing a user equipment 110 measured value of the at least one parameter for at least one non-serving cell of the user equipment 110
means for using the data representing the user equipment 110 measured value of the at least one parameter for at least one non-serving cell of the user equipment 110 to determine availability of the at least one non-serving cell suitable for use by the user equipment 110;
generating labeled training data comprising:
the data representing the user equipment 110 measured value of the at least one parameter for the serving cell of the user equipment 110, labelled with the serving cell and comprising, explicitly or implicitly, a label that indicates availability of the at least one non-serving cell suitable for use by the user equipment 110; and
using the labeled training data for supervised training of a machine learning model, wherein the machine learning model predicts availability of a non-serving cell, suitable for use, in response to an input comprising the serving cell and data representing a user equipment 110 measured value of the at least one parameter for the serving cell.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 406. The illustration of a particular order to the blocks does not necessarily imply that there is a required or preferred order for the blocks and the order and arrangement of the block may be varied.

Furthermore, it may be possible for some blocks to be omitted.

Where a structural feature has been described, it may be replaced by means for performing one or more of the functions of the structural feature whether that function or those functions are explicitly or implicitly described.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

As used here ‘module’ refers to a unit or apparatus that excludes certain parts/components that would be added by an end manufacturer or a user.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “ determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such Structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1-27. (canceled)

28. An apparatus, comprising:
at least one processor, and
at least one memory storing instructions that, when executed by the at least one processor, cause the apparatus to perform:
making radio measurements for radio cells in a first set, but not a second set;
using the radio measurements to obtain a prediction of availability, for connection, of the second set of radio cells, wherein the first set of radio cells and the second set of radio cells are distinct having no cells in common; and
in dependence upon the prediction, making radio measurements for connection to a radio cell in the second set.

29. The apparatus as claimed in claim 28, wherein the instructions, when executed by the at least one processor, cause the apparatus to perform: skipping or suspending making some or all radio measurements for radio cells of the second set until a radio cell of the second set is predicted as available for connection and then making radio measurements for the radio cell of the second set predicted as available.

30. The apparatus as claimed in claim 28, wherein the instructions, when executed by the at least one processor, cause the apparatus to perform: enabling use of the radio measurements for radio cells in the first set as input to a trained machine learning model trained to predict availability, for connection, of the second set of radio cells.

31. The apparatus as claimed in claim 30, wherein the trained machine learning model is comprised in the apparatus.

32. The apparatus as claimed in claim 30, wherein the instructions, when executed by the at least one processor, cause the apparatus to perform: providing labeled training data for training the machine learning model at a network node, wherein the labeled training data comprises radio measurements for multiple cells in the first set labelled explicitly or implicitly, using availability of the second set of cells for contemporaneous connection by the apparatus.

33. The apparatus as claimed in claim 28, wherein the instructions, when executed by the at least one processor, cause the apparatus to perform: making radio measurements for radio cells, including a primary radio cell and one or more neighboring cells, in the first set when the apparatus is at the primary radio cell of the first set; and
using the radio measurements to obtain a prediction of availability, for connection, of the apparatus at the primary radio cell, to a second set of radio cells.

34. The apparatus as claimed in claim 28, wherein the first set of radio cells operate at a first frequency range and the second set of radio cells operate at a second frequency range, non-overlapping the first frequency range and wherein the radio measurements for radio cells in the first set are measured in the first frequency range not the second frequency range.

35. The apparatus as claimed in claim 28, wherein the first set of radio cells operate using a first radio access technology and the second set of radio cells operate using a second radio access technology, different to the first radio access technology and wherein the radio measurements for radio cells in the first set are measured using the first radio access technology not the second radio access technology.

36. The apparatus as claimed in claim 28, wherein the first set of radio cells operate within a first macro layer and the second set of radio cells operate within a second micro layer, different to and partially physically overlapping the first macro layer, wherein the first macro layer comprises radio cells that physically overlap to blanket cover a first area and wherein the second micro layer comprises one or more isolated, non-overlapping, clusters of one or more radio cells that, in combination, only partially cover the first area.

37. The apparatus as claimed in claim 28, wherein the first set of radio cells operate within a first coverage layer and the second set of radio cells operate within a second capacity layer, different to and partially overlapping in space the first coverage layer, wherein the coverage layer is configured for larger area coverage at lower quality of service and the second capacity layer is configured for relatively smaller area coverage at relatively higher quality of service.

38. The apparatus as claimed in claim 28, wherein the instructions, when executed by the at least one processor, cause the apparatus to perform: making radio measurements for the radio cell of the second set predicted as available for connection, and in dependence upon the radio measurements for the radio cell of the second set subsequently changing a serving radio cell of the apparatus from a radio cell in the first set to a radio cell in the second set.

39. A method, comprising:
making radio measurements for radio cells in a first set, but not a second set;
using the radio measurements to obtain a prediction of availability, for connection, of the second set of radio cells, wherein the first set of radio cells and the second set of radio cells are distinct having no cells in common; and
in dependence upon the prediction, making radio measurements for connection to a radio cell in the second set.

40. An apparatus, comprising:
at least one processor, and
at least one memory storing instructions that, when executed by the at least one processor, cause the apparatus to perform:
using radio measurements for radio cells in a first set to enable prediction of availability, for connection, of a second set of radio cells, wherein the first set of radio cells and the second set of radio cells are distinct having no cells in common.

41. The apparatus as claimed in claim 40, wherein the radio measurements are user equipment radio measurements received from user equipment.

42. The apparatus as claimed in claim 40, wherein the instructions, when executed by the at least one processor, cause the apparatus to perform: using the radio measurements for radio cells in the first set to train a machine learning model to predict availability, for connection, of the second set of radio cells.

43. The apparatus as claimed in claim 40, wherein the instructions, when executed by the at least one processor, cause the apparatus to perform: using radio measurements for radio cells, including a primary radio cell and possible one or more neighboring cells, in the first set made by user equipment at the primary radio cell of the first set, to enable prediction of availability, for connection by a user equipment at the primary radio cell, to a second set of radio cells.

44. The apparatus as claimed in claim 43, wherein the instructions, when executed by the at least one processor, cause the apparatus to perform: training a machine learning model using labeled training data for supervised training of the machine learning model, wherein the labeled training data comprises radio measurements for multiple cells in the first set labelled explicitly or implicitly, using availability of the second set of cells for contemporaneous connection by the user equipment at the primary radio cell, wherein the trained machine learning model is thus configured to predict availability of the second set of cells for connection by a user equipment at the primary radio cell, in response to an input comprising radio measurements for multiple cells in the first set made by the user equipment at the primary radio cell.

45. The apparatus as claimed in claim 40, wherein the first set represents radio cells of a first radio access network layer and wherein the second set represents radio cells of a second radio access network layer distinct from the first radio access network layer.

46. The apparatus as claimed in claim 40, wherein the instructions, when executed by the at least one processor, cause the apparatus to perform: predicting availability to an arbitrary user equipment, for connection, of a second set of radio cells, in response to radio measurements from the arbitrary user equipment for radio cells in the first set.

47. The apparatus as claimed in claim 40, wherein the instructions, when executed by the at least one processor, cause the apparatus to perform: receiving for each of multiple user equipment radio measurements for radio cells in the first set to enable prediction of availability, for connection, of the second set of radio cells.
